(19) United States
(12) Patent Application Publication
(10) Pub. No.: US 2026/0297334 A1
(43) Pub. Date: Oct. 1, 2026

(54) WATER-BORNE POLYMER EMULSION AND LIQUID APPLIED SOUND DAMPING FORMULATION COMPRISING THE SAME

(71) Applicant: BASE SE, Ludwigshafen am Rhein (DE)

(72) Inventors: Peng ZHANG, Shanghai (CN); Jin Kun HAO, Shanghai (CN); Guang Jia SHENG, Shanghai (CN); An Lin PANG, Shanghai (CN); Yang Yang SU, Shanghai (CN); Chen LIU, Shanghai (CN)

(21) Appl. No.: 19/478,871

(22) PCT Filed: Apr. 26, 2024
(86) PCT No.: PCT/CN2024/090091

§ 371 Date: Oct. 27, 2025

(30) Foreign Application Priority Data
Apr. 28, 2023 (WO) PCT/CN2023/091658

(51) Int. Cl. C09D 5/02; C09D 7/45; C09D 7/63; C09D 7/65; C09D 133/06

(52) U.S. Cl. CPC C09D 5/022; C09D 5/027; C09D 7/45; C09D 7/63; C09D 7/65; C09D 133/064; C09D 133/066

(57) ABSTRACT

The present invention is directed to water-borne polymer emulsion, method for making the water-borne polymer emulsion, liquid applied sound damping formulation comprising the water-borne polymer emulsion and to use of the polymer emulsions in liquid applied sound damping formulation.

### TECHNICAL FIELD

The present invention is directed to water-borne polymer emulsion, method for making the water-borne polymer emulsion, liquid applied sound damping formulation comprising the water-borne polymer emulsion and to use of the polymer emulsions in liquid applied sound damping formulation.

### BACKGROUND

Noise, Vibration, and Harshness (NVH) are widely present in vehicles and other areas (e.g. construction materials, household appliances). One of the most common ways to reduce vibration is Bitumen pad which are thick patches that adhere to metallic or plastic parts of the body or frame. It is cumbersome to use, firstly it needs to cut to specific shape to fit for different car mode and different parts, secondly large storage area is required and logistic is complicate. Thirdly, it installs by worker, lots of labor work are necessary, overall, it is costly and inefficient. Besides high VOC and odor are harm to the health of worker and car passenger. Because of the weakness of Bitumen pad, other technologies were arisen, such as rubber, PVC, Epoxy based Non aqueous LASD (liquid applied sound damping) material, these materials usually contain solvent, or plasticizer, it is still not very environmental and health friendly.

Water borne (WB) LASD is a new arising technology in the past 2 decades. Viscoelasticity of polymer offer the possibility to dampen sound vibration through heat dissipation when operated in the vicinity of their glass transition temperature (Tg). Comparing with the traditional technology, water borne LASD has several advantages: 1) automated, it can be applied by robot spraying, much less labor needed; 2) simple logistic and storage, because no need to cut to specific shape; 3) high damping efficiency, means low coat weight is possible; 4) High filler content possible; 5) Environment friendly (solvent free, low VOC).

Therefore, there is a great demand to provide a water-borne LASD formulation showing improved damping performance and being able to applied in reduced weight.

### SUMMARY OF THE INVENTION

It is an object of this disclosure to provide a water-borne polymer emulsion, it enables to prepare a liquid applied sound damping formulation showing improved adherence, appearance, damping performance and being able to be applied in reduced weight.

Another object of this disclosure is to provide a method for making the polymer emulsion.

A further object of this disclosure is to provide a liquid applied sound damping formulation comprising the polymer emulsion.

A further object of this disclosure is to provide use of the polymer emulsion of the present invention in liquid applied sound damping formulation.

It has been surprisingly found that the above objects can be achieved by following embodiments:

1. A water-borne polymer emulsion comprises:
(A) a copolymer prepared by polymerization of at least one hydrophobic monoethylenically un saturated monomer (a), hydrophilic monoethylenically unsaturated monomer (b), and at least one functional monomer (c);
   wherein the functional monomer (c) is selected from the group consisting of an ethylenically unsaturated monomer having an acid group and/or the corresponding anion thereof, an ethylenically unsaturated monomer having an amino, amido, ureido, 1,3-diketo group, hydroxyl, polyether chain, or N-heterocyclic group and/or protonated on the nitrogen, or alkylated ammonium derivatives thereof;
   wherein the functional monomer (c) is different from monomer (a) and monomer (b); and
(B) an emulsifier system, wherein the emulsifier system comprises at least one phosphate emulsifier.

2. The water-borne polymer emulsion according to item 1, wherein the total amount of hydrophobic monoethylenically unsaturated monomers (a) may be in an amount of at least 80% by weight or from 80 to 99% by weight, preferably at least 85% by weight, more preferably at least 90% by weight, and mostly preferably at least 95% by weight, based on the total amount of all monomers.

3. The water-borne polymer emulsion according to item 1 or 2, wherein the total amount of hydrophilic monoethylenically unsaturated monomers (b) may be in an amount of at least 0.1% by weight and no more than 20% by weight, preferably no more than 15% by weight, more preferably no more than 10% by weight, and mostly preferably no more than 5% by weight, based on the total amount of all monomers.

4. The water-borne polymer emulsion according to any of item 1 to 3, wherein the hydrophobic monoethylenically unsaturated monomer (a) is selected from the group consisting of (meth)acrylate monomers, (meth)acrylonitrile monomers, styrene monomers, vinyl alkanoate monomers and monoethylenically unsaturated di- and tricarboxylic ester monomers.

5. The water-borne polymer emulsion according to any of item 1 to 4, wherein the hydrophilic monoethylenically unsaturated monomer (b) is selected from the group consisting of monoethylenically unsaturated dicarboxylic acid, acrylic acid, methacrylic acid and β-carboxyethyl acrylate.

6. The water-borne polymer emulsion according to any of item 1 to 5, wherein the hydrophilic monoethylenically unsaturated monomer (b) comprises at least two monomers selected from itaconic acid, acrylic acid, methacrylic acid and β-carboxyethyl acrylate.

7. The water-borne polymer emulsion according to any of item 1 to 6, wherein the functional monomer (c) comprises at least two monomers selected from the group consisting of an ethylenically unsaturated monomer having an acid group and/or the corresponding anion thereof, an ethylenically unsaturated monomer having an amino, amido, ureido, 1,3-diketo group, hydroxyl, polyether chain, or N-heterocyclic group and/or protonated on the nitrogen, or alkylated ammonium derivatives thereof.

8. The water-borne polymer emulsion according to any of item 1 to 7, wherein the copolymer (A) is prepared by one-phase polymerization.

9. The water-borne polymer emulsion according to any of item 1 to 8, wherein the copolymer (A) is prepared by two-phase polymerization, wherein the monomers for the first-phase comprise monomer (a), and (b) and/or (c), the monomers for the second-phase comprise monomer (a), and optionally (b) and/or (c), wherein the weight ratio of the first-phase polymer:second-phase polymer is in the range of 95:5 to 40:60, preferably in the range of 90:10 to 40:60, more preferably in the range of 90:10 to 50:50.

10. The water-borne polymer emulsion according to any of item 1 to 9, wherein the emulsion has a particle size in the range of 50-300 nm, preferably in the range of 50-250 nm, and most preferably in the range of 50-200 nm.

11. A method for making the polymer emulsions according to item 8 or 10, comprising: preparing copolymer (A) by polymerization of monomer (a), monomer (b), and monomer (c) and adding the emulsifier system (B) before, after or during the polymerization.

12. A method for making the polymer emulsions according to item 9 or 10, comprising:
Step 1: preparing the first-phase polymer by polymerizing the monomers for the first phase;
Step 2: subsequently preparing the second-phase polymer by polymerizing the monomers for the second phase;
adding emulsifier system (B) before, after or during the polymerization.

13. A liquid applied sound damping formulation comprising the polymer emulsion according to any of the items 1 to 10.

14. Use of the polymer emulsions according to any of the items 1 to 10 in liquid applied sound damping formulation.

The water-borne polymer emulsion of the present invention enables to prepare a liquid applied sound damping formulation showing improved adherence, appearance and damping performance (for example high loss coefficient, high damping peak and broad damping curve), being able to be applied in reduced weight and lower cost and the liquid applied sound damping formulation can have higher filler content.

### DETAILED DESCRIPTION OF THE INVENTION

In the below description, further explanations to the present disclosure are made with reference to embodiments so as to facilitate sufficient understanding for skilled person in the art. It should be understood that these embodiments are provided merely for better understanding the subject matter of the present disclosure, not for making any limitations to the protection scope, applicability or embodiments as described in the present claims set. It should be understood that, skilled person in the art can omit, replace, or add various technical features to each embodiment based on actual needs, subject to the premise of without departing from the spirit of the present disclosure. In addition, technical features described in some embodiments can be combined with technical features described in other embodiments.

Unless defined otherwise, all technical and scientific terms used herein have the same meanings as commonly understood by skilled person in the art to which the present disclosure belongs.

In the present disclosure, terms “comprise”, “comprising”, “include”, “including” and various variants thereof can be understood as open-ended terms, which means “include but are not limited to”; in contrast, the term “consisting of” and various variants thereof excludes any component, step or procedure not specifically listed; the term “an embodiment” can be understood as “at least one embodiment”; the term “another embodiment” may be understood as “at least one other embodiment.” Other terms that may appear but are not mentioned here, unless explicitly stated, should not be interpreted or limited in a manner that is contrary to the concept on which the embodiments of the present disclosure are based.

Throughout the present disclosure, expressions “a”, “an”, “the” and “one or more” are used interchangeably and are intended to include both the plural and the singular except in cases where the singular alone is explicitly specified or is clearly indicated by the context. When the singular alone is intended for, the term “one” is typically used. The term “or” is generally intended to include the sense of “and/or” unless the content clearly dictates otherwise. “Preferred”, “preferable” and “preferably” as used herein refer to embodiments of the present disclosure that may bring certain advantages under certain situations. However, other embodiments may also be preferred, under the same situations. Further, the recitation of one or more preferred embodiments does not mean that other embodiments are not useful and is not intended to exclude other embodiments from the scope of the present disclosure.

All percentages, ppm, parts and ratios are by weight, unless otherwise specified. And the recitation of numerical ranges by end values includes all numbers subsumed within that range (e.g., 5 to 10 includes 5, 5.1, 5.2, 5.55, 6, 6.5, 7, 7.5, 8, 8.5, 9, 9.5, 10).

In the context of the present disclosure, any specific values mentioned for a feature (comprising the specific values mentioned in a range as the end point) can be re-combined to form a new range.

### Water-Borne Polymer Emulsion

In one aspect, the present invention is directed to a water-borne polymer emulsion comprises:
(A) a copolymer prepared by polymerization of at least one hydrophobic monoethylenically un saturated monomer (a), hydrophilic monoethylenically unsaturated monomer (b), and at least one functional monomer (c); 30
   wherein the functional monomer (c) is selected from the group consisting of an ethylenically unsaturated monomer having an acid group and/or the corresponding anion thereof, an ethylenically unsaturated monomer having an amino, amido, ureido, 1,3-diketo group, hydroxyl, polyether chain, or N-heterocyclic group and/or protonated on the nitrogen, or alkylated ammonium derivatives thereof;
   wherein the functional monomer (c) is different from monomer (a) and monomer (b); and
(B) an emulsifier system, wherein the emulsifier system comprises at least one phosphate emulsifier.

### Hydrophobic Monoethylenically Unsaturated Monomer (a)

In an embodiment, the hydrophobic monoethylenically unsaturated monomer (a) is selected from the group consisting of (meth)acrylate monomers, (meth)acrylonitrile monomers, styrene monomers, vinyl alkanoate monomers and monoethylenically unsaturated di- and tricarboxylic ester monomers.

Exemplary (meth)acrylate monomer can include C₁ to C₁₈ alkyl (meth)acrylate and C₃ to C₁₀ cycloalkyl (meth)acrylate, benzyl (meth)acrylate, phenyl (meth)acrylate and a mixture thereof.

C₁ to C₁₈ alkyl (meth)acrylate can include methyl (meth)acrylate, ethyl (meth)acrylate, isopropyl (meth)acrylate, n-propyl (meth)acrylate, n-butyl (meth)acrylate, isobutyl (meth)acrylate, tert-butyl (meth)acrylate, sec-butyl (meth)acrylate, pentyl (meth)acrylate, n-hexyl (meth)acrylate, octyl (meth)acrylate, isooctyl (meth)acrylate, 2-ethylhexyl (meth)acrylate, decyl (meth)acrylate, isodecyl (meth)methacrylate, n-lauryl (meth)acrylate, n-tridecyl (meth)acrylate, n-cetyl (meth)acrylate, n-stearyl (meth)acrylate, isomyristyl (meth)acrylate, stearyl (meth)acrylate, and isostearyl (meth)acrylate (ISTA). C₁ to C₁₂ alkyl (meth)acrylate, especially C₁ to C₆ alkyl (meth)acrylate is preferred.

Specific examples of C₃ to C₁₀ cycloalkyl (meth)acrylate can include isobornyl acrylate, isobornyl methacrylate, cyclohexyl acrylate or cyclohexyl methacrylate.

In an embodiment, the hydrophobic monoethylenically unsaturated monomer (a) can comprises two or more of C₁ to C₁₈ alkyl (meth)acrylate and C₃ to C₁₀ cycloalkyl (meth)acrylate, preferably two C₁ to C₁₈ alkyl (meth)acrylates.

Particularly, the styrene monomers may be unsubstituted styrene or C₁-C₆-alkyl substituted styrene, for example, but not limited to, styrene, α-methylstyrene, ortho-, meta- and paramethylstyrene, ortho-, meta- and para-ethylstyrene, o,p-dimethylstyrene, o,p-diethylstyrene, isporopylstyrene, o-methyl-p-isopropylstyrene or any mixture thereof.

Particularly, the vinyl alkanoate monomers may be vinyl esters of C₂-C₁₁-alkanoic acids (for example C₂-C₆-alkanoic acids), for example, but not limited to, vinyl acetate, vinyl propionate, vinyl butanoate, vinyl valerate, vinyl hexanoate, vinyl versatate or a mixture thereof.

Particularly, the monoethylenically unsaturated di- and tricarboxylic ester monomers may be full esters of monoethylenically unsaturated di- and tricarboxylic acids, for example, but not limited to, diethyl maleate, dimethyl fumarate, ethyl methyl itaconate or any mixture thereof.

In a preferred embodiment, the hydrophobic monoethylenically unsaturated monomer (a) comprises two hydrophobic monoethylenically unsaturated monomers.

In a preferred embodiment according to the present invention, one or two or more C₁-C₁₂-alkyl (meth)acrylates, such as methyl (meth)acrylate, ethyl (meth)acrylate, n-butyl (meth)acrylate, 2-ethylhexyl (meth)acrylate, or a mixture thereof is chosen as the at least one hydrophobic monoethylenically unsaturated monomer (a).

According to the present invention, the hydrophobic monoethylenically unsaturated monomer (a) is different from functional monomer (c).

The total amount of hydrophobic monoethylenically unsaturated monomers (a) may be in an amount of at least 80% by weight, preferably at least 85% by weight, more preferably at least 90% by weight, and mostly preferably at least 95% by weight, based on the total amount of all monomers. In an embodiment, the total amount of hydrophobic monoethylenically unsaturated monomers (a) may be in the range from 80 to 99% by weight, or from 85 to 98% by weight, or from 90 to 97% by weight, based on the total amount of all monomers.

### Hydrophilic Monoethylenically Unsaturated Monomer (b)

In an embodiment, the hydrophilic monoethylenically unsaturated monomer (b) contains carboxyl or anhydride thereof.

In an embodiment, the hydrophilic monoethylenically unsaturated monomer (b) comprises at least two (for example two or three or four) hydrophilic monoethylenically unsaturated monomers.

Particularly, the hydrophilic monoethylenically unsaturated monomer include, but are not limited to, monoethylenically unsaturated carboxylic acids, such as (meth)acrylic acid, B-carboxyethyl acrylate, itaconic acid, fumaric acid, citraconic acid, sorbic acid, cinnamic acid, glutaconic acid and maleic acid; monoethylenically unsaturated carboxylic anhydrides, such as itaconic acid anhydride, fumaric acid anhydride, citraconic acid anhydride, sorbic acid anhydride, cinnamic acid anhydride, glutaconic acid anhydride and maleic acid anhydride.

In a preferred embodiment, the hydrophilic monoethylenically unsaturated monomer (b) comprises itaconic acid, methacrylic acid or a mixture thereof. In a more preferred embodiment, the hydrophilic monoethylenically unsaturated monomer (b) comprises a mixture comprising itaconic acid or methacrylic acid, for example a mixture comprising itaconic acid and methacrylic acid, a mixture comprising itaconic acid and acrylic acid, a mixture comprising methacrylic acid and acrylic acid, a mixture comprising itaconic acid, meth-acrylic acid and acrylic acid.

The total amount of hydrophilic monoethylenically unsaturated monomers (b) may be in an amount of at least 0.1% by weight and no more than 20% by weight (for example 0.2% by weight, 0.5% by weight, 0.8% by weight, 1% by weight, 2% by weight, 5% by weight, 10% by weight, or 15% by weight), preferably no more than 15% by weight, more preferably no more than 10% by weight, and mostly preferably no more than 5% by weight, based on the total amount of all monomers. In an embodiment, the total amount of hydrophilic monoethylenically unsaturated monomers (b) may be in the range from 0.1 to 20% by weight, from 0.2 to 15% by weight, from 0.5 to 10% by weight, or from 1 to 5% by weight, based on the total amount of all monomers.

### Functional Monomer (c)

According to the present invention, the functional monomer (c) is selected from the group consisting of an ethylenically unsaturated monomer having an acid group and/or the corresponding anion thereof, an ethylenically unsaturated monomer having an amino, amido, ureido, 1,3-diketo group, hydroxyl, polyether chain, or N-heterocyclic group and/or protonated on the nitrogen, or alkylated ammonium derivatives thereof; wherein the functional monomer (c) is different from monomer (a) and monomer (b).

According to the present invention, the acid group mentioned for the functional monomer (c) does not include carboxyl group. In an embodiment, the acid group can be selected from sulfonic acid, phosphonic acid or phosphoric acid group.

In an embodiment, the functional monomer (c) comprises at least two functional monomers.

Examples of ethylenically unsaturated monomer having an acid group and/or the corresponding anion thereof are monoethylenically unsaturated sulfonic acids, such as vinyl sulfonic acid, styrene sulfonic acid, acryloxyethansulfonic acid and acrylamido-2-methylpropane sulfonic acid and the salts thereof, in particular the alkali metal salts thereof; monoethylenically unsaturated phosphonic acids such as vinylphosphonic acid, allylphosphonic acid, styrenephosphonic acid and 2-acrylamido-2-methylpropane phosphonic acid and the salts thereof, in particular the alkali metal salts thereof; and also monoethylenically unsaturated phosphoric acids and the salts thereof, in particular the alkali metal salts thereof.

Examples of ethylenically unsaturated monomer having an amido group are monoethylenically unsaturated amides, such as (meth)acrylamide, N-methylol (meth)acrylamide, N,N-dimethylacrylamide (DMA), 2-hydroxyethyl (meth)acrylamide, dimethylaminoethylmethacrylamide.

Examples of ethylenically unsaturated monomer having a hydroxyl are hydroxyalkyl (for example C₂ to C₆ alkyl) esters of monoethylenically unsaturated carboxylic acids (for example (meth)acrylic acid), such as hydroxyethyl (meth)acrylate and hydroxypropyl (meth)acrylate, and glycerol (meth)acrylate.

Examples of ethylenically unsaturated monomer having a 1,3-diketo group are monomers containing 1,3-diketo groups (e.g., acetoacetoxyethyl (meth)acrylate or diacetone acrylamide).

Examples of ethylenically unsaturated monomer having a ureido are monomers containing urea groups (e.g., ureidoethyl (meth)acrylate, acrylamidoglycolic acid, and methacrylamidoglycolate methyl ether).

Examples of ethylenically unsaturated monomer having a polyether chain are monomers containing polyalkylene oxide chain, preferably alkylene oxide having 2 to 6, more preferably 2 to 4, or 2 or 3, most preferably 2 carbon atoms, for example the alkylene oxide can be ethylene oxide, propylene oxide or mixture thereof. The molecular weight of the polyether chain can be in the range from 132 to 3000, or from 250 to 2000, or from 300 to 1500, or from 300 to 1000. In an embodiment, the ethylenically unsaturated monomer having a polyether chain carries one (meth)acrylate (ester) group.

The N-heterocycle mentioned for monomer (c) can have 1 to 3 nitrogen atoms. In addition to the nitrogen atoms there may also, optionally, be further 1 to 2 heteroatoms (for example N, O or S) present in the ring. The N-heterocycle can have 5 or 6 ring members. Examples of ethylenically unsaturated monomer having a N-heterocyclic group are 2-vinylpyridine, 4-vinylpyridine, 1-vinylimidazole, 4-vinylimidazole, 1-vinylpyrazole or 1-vinyl-1,2,4-triazole.

In a preferred embodiment, the functional monomer (c) comprises an ethylenically unsaturated monomer having an acid group and/or the corresponding anion thereof, an ethylenically unsaturated monomer having an 1,3-diketo group, an ethylenically unsaturated monomer having a hydroxyl or an ethylenically unsaturated monomer having polyether chain, or a mixture comprises two, three or four of these monomers. In a preferred embodiment, the functional monomer (c) comprises an ethylenically unsaturated monomer having an acid group and/or the corresponding anion thereof, an ethylenically unsaturated monomer having an 1,3-diketo group and an ethylenically unsaturated monomer having a hydroxyl.

The functional monomer (c) is present in an amount of 0.5 to 15% by weight (for example 1.0, 1.5, 2, 2.5, 3, 4, 5, 8, 10, or 12% by weight), preferably 1.0 to 10% by weight, more preferably 1.5 to 5% by weight, based on the total amount of all monomers.

In this context, the expression “a copolymer prepared by polymerization of” mentioned for component (A)” or similar expression does not mean a close-ended mode. In addition to monomers (a), (b) and (c), further monomers can be included if desired.

### Emulsifier System (B)

According to the present invention, the emulsifier system comprises at least one phosphate emulsifier.

The phosphate emulsifier can be selected from compounds of the formula (I), (II) or a mixture thereof:

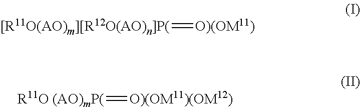

in which R¹¹ and R¹² are independently a C₆-C₃₀ alkyl, benzene and benzene derivative, m and n are independently an integer from 0 to 20, AO is alkyleneoxy, and M¹¹ and M¹² are independently a H or cationic ion.

The R¹¹ and R¹² are independently a C₆-C₃₀ alkyl, benzene and benzene derivative. The C₆-C₃₀ alkyl can be chosen from linear/branched/cyclic C₆-C₃₀ alkyl, preferably linear/branched/cyclic C₈-C₂₅ alkyl, more preferably linear/branched/cyclic C₈-C₂₀ alkyl. Benzene and benzene derivative can be chosen from benzene, C₁-C₁₅ alkyl benzyl, C₁-C₂₀ alkyl benzoate and aryloxy. Preferably, benzene and benzene derivative can be chosen from benzene, C₂-C₁₂ alkyl benzyl, C₂-C₁₅ alkyl benzoate and aryloxy. More preferably, benzene and benzene derivative can be chosen from benzene, C₄-C₈ alkyl benzyl, C₄-C₁₀ alkyl benzoate and aryloxy.

The number m and n are independently an integer from 0 to 20 (for example 1, 2, 3, 4, 5, 6, 8, 10, 12, 15, 16 or 18), preferably from 1 to 15, more preferably 1 to 12 and most preferably 2 to 12.

AO is alkyleneoxy, which can preferably have 2 to 6 or 2, 3 or 4 carbon atoms, which can preferably be chosen from (—CH₂CH₂O—), (—CH₂CH₂CH₂O—) and (—CH₂(CH₃)CHO—).

M¹¹ and M¹² are independently a H or cationic ion, such as Li⁺, Na⁺, K⁺ and NH₄⁺. Many of the abovementioned compound is commercially available, such as Rhodafac RS410, RS610, RS710 and PE3501 (from Solvay) and Disponil FEP 3825 PN, Disponil FEP 6300 and Maphos 24T (from BASF), and TERIC 305 (from Huntsman), etc.

A compound of formula (I) or formula (II) may be used alone or in combination.

The amount of phosphate emulsifier, preferably, the compound of formula (I) or formula (II) or in combination may be, based on the total weight of the water-borne polymer emulsion, 0.2 to 10% by weight, preferably 0.5 to 8% by weight, more preferably 1 to 5% by weight and most preferably 1 to 4% by weight.

The emulsifier system (B) can be added before, after or during the polymerization

Besides compounds of formula (I) or formula (II), other suitable emulsifiers may further be used. Those emulsifiers include, but not limited to, at least one nonionic emulsifier, anionic emulsifier, or cationic emulsifier.

The nonionic emulsifier in the emulsifier system is selected from the group consisting of ethoxylated mono-, di-, and tri-alkylphenols and ethoxylated fatty alcohols or alkylphenol/fatty alcohol with polymerizable moiety. Examples thereof are those available from BASF SE Trademark Lutensol® A (C₁₂C₁₄ fatty alcohol ethoxylate, EO degree: 3 to 8), Trademark Lutensol® AO (C₁₃C₁₅ oxo-alcohol ethoxylate, EO degree: 3 to 30), Trademark Lutensol® AT (C₁₆C₁₈ fatty alcohol ethoxylate, EO degree: 11 to 80), Trademark Lutensol® ON (C₁₀ oxo-alcohol, EO degree: 3 to 11) and Trademark Lutensol® TO (C₁₃ oxo-alcohol, EO degree: 3 to 20).

The anionic emulsifier in the emulsifier system is selected from the group consisting of alkali metal salts and ammonium salts of alkyl sulfates, of sulfuric monoesters with ethoxylated alkanols and with ethoxylated alkylphenols, of alkylsulfonic acids, and of alkylarylsulfonic acids and a combination thereof.

Suitable anionic emulsifiers also include compounds of the general formula (III),

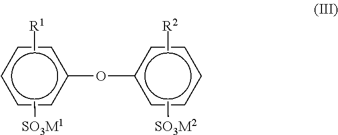

wherein R¹ and R² is H atom or C₁ to C₂₄ alkyl radical, with the proviso that R¹ and R² are not H at the same time, and M¹ and M² may be an alkali metal ion and/or an ammonium ion. In the general formula (III), R¹ and R² preferably have 6 to 18 carbon atoms, more particularly 6 carbon atoms. M¹ and M² preferably is sodium, potassium or ammonium, sodium. Of particular advantage M¹ and M² are all sodium, R¹ is a branched alkyl group of 12 carbon atoms and R² is H atom or R¹.

And the cationic emulsifier in the emulsifier system is selected from the group consisting of positively charged amines and quaternary ammonium compounds.

The amount of emulsifier system (B) may be, based on the total weight of the water-borne polymer emulsion, 0.2 to 12% by weight, preferably 0.5 to 10% by weight, more preferably 1 to 8% by weight and most preferably 1.2 to 5% by weight.

The amount of copolymer (A) can be in the range of 8 to 70% by weight, preferably 15 to 60% by weight, more preferably 25 to 60% by weight, and most preferably 35 to 60% by weight, based on the total weight of the water-borne polymer emulsion.

The emulsion according to the present invention may have a solid content in the range of 10% to 70% by weight, preferably 20% to 60% by weight, more preferably 30 to 60% by weight, and most preferably 40 to 60% by weight.

In an embodiment, the copolymer (A) is prepared by one-phase polymerization.

In another embodiment, the copolymer (A) is prepared by two-phase polymerization, wherein the monomers for the first-phase comprise monomer (a), and (b) and/or (c), the monomers for the second-phase comprise monomer (a), and optionally (b) and/or (c), wherein the weight ratio of the first-phase polymer:second-phase polymer is in the range of 95:5 to 40:60, preferably in the range of 90:10 to 40:60, more preferably in the range of 90:10 to 50:50. In this regard, if the monomers for the first-phase does not comprise monomer (b), then the monomers for the second-phase comprise monomer (b); and if the monomers for the first-phase does not comprise monomer (c), then the monomers for the second-phase comprise monomer (c).

The glass transition temperature Tg of the copolymer obtainable by emulsion polymerization can in principle be in the range from −30 to 30° C. (for example −25, −20, −15, −10, −5, 0, 5, 10, 20, or 25° C.), preferably −20 to 20° C., or −10 to 10° C. The glass transition temperature Tg is understood here to mean the actual glass transition temperature which is the midpoint temperature determined by means of Differential Scanning calorimetry (DSC) according to ASTM D3418-82 [see also Ullmann's Encyclopedia of Industrial Chemistry, p. 169, Verlag Chemistry, Weinheim, 1992].

A theoretical glass transition temperature can be calculated from the monomers used in the emulsion polymerization. The theoretical glass transition temperatures are usually calculated from the monomers by the Fox equation:

$$1 / {Tg}^{t} = {x}_{a} / {Tg}_{a} + {x}_{b} / {Tg}_{b} + … {x}_{n} / {Tg}_{n} ,$$

In this equation xₐ, x_{b}, . . . xₙ are the mass fractions of the monomers a, b, . . . n and Tgₐ, Tg_{b}, . . . Tgₙ are the actual glass transition temperatures in Kelvin of the homopolymers synthesized from only one of the monomers 1, 2, . . . n at a time. The Fox equation is described by T. G. Fox in Bull. Am. Phys. Soc. 1956, 1, page 123 and as well as in Ullmann's Encyclopädie der technischen Chemie [Ullmann's Encyclopedia of Industrial Chemistry], vol. 19, p. 18, 4th ed., Verlag Chemie, Weinheim, 1980. The actual Tg values for the homopolymers of most monomers are known and listed, for example, in Ullmann's Encyclopädie der technischen Chemie [Ullmann's Encyclopedia of Industrial Chemistry], 5th ed., vol. A21, p. 169, Verlag Chemie, Weinheim, 1992. Further sources of glass transition temperatures of homopolymers are, for example, J. Brandrup, E. H. Immergut, Polymer Handbook, 1st Ed., J. Wiley, New York 1966, 2nd Ed. J. Wiley, New York 1975, 3rd Ed. J. Wiley, New York 1989 and 4th Ed. J. Wiley, New York 2004.

Usually, the theoretical glass temperature Tg^{t} calculated according to Fox as described herein and the experimentally determined glass transition temperature as described herein are similar or even same and do not deviate from each other by more than 5 K, in particular they deviate not more than 2 K. Accordingly, both the actual and the theoretical glass transition temperatures of the copolymer can be adjusted by choosing proper monomers Ma, Mb . . . Mn and their mass fractions xₐ, x_{b}, . . . xₙ in the monomers so to arrive at the desired glass transition temperature Tg(1) and Tg(2), respectively. It is common knowledge for a skilled person to choose the proper amounts of monomers Ma, Mb . . . Mn for obtaining a copolymer and/or copolymer phase with the desired glass transition temperature.

In an embodiment, the theoretical glass transition temperature of the resulting polymer formed in one phase remains almost the same of or differs from the theoretical glass transition temperature of the resulting polymer formed in another phase by at least 10° C., in particular by at least 20° C. or at least 40° C. The calculation of the theoretical glass transition temperature is described below.

In an embodiment, the theoretical glass transition temperature of second-phase polymer remains almost the same of or is higher than the theoretical glass transition temperature of the first-phase polymer by at least 10° C., in particular by at least 20° C. or at least 40° C.

Of course, the theoretical glass transition temperature of the resulting polymer formed in one phase can differ from the theoretical glass transition temperature of the resulting polymer formed in another phase by no more than 10° C., or no more than 5° C.

In an embodiment, the theoretical glass transition temperature of first-phase polymer is in the range from −30 to 30° C. (for example −25° C., −20° C., −15° C., −10° C., −5° C., 0° C., 5° C., 10° C., 15° C., 20° C., or 25° C.), preferably from −20 to 20° C., from −10 to 10° C., or from −5 to 5° C.

In a preferred embodiment, water-borne polymer emulsion of the present invention has a particle size in the range of 50-300 nm, preferably in the range of 50-250 nm, and most preferably in the range of 50-200 nm.

According to the present invention, the copolymer (A) is neutralized.

### Method for Making the Polymer Emulsions

One aspect of the present invention relates to a method for making the polymer emulsions according of the present invention, comprising:
preparing copolymer (A) by polymerization of monomer (a), monomer (b), and monomer (c) and adding the emulsifier system (B) before, after or during the polymerization.

The method for making the emulsion of the present disclosure may be a single phase polymerization or a multi-phase emulsion polymerization. In a single phase polymerization, the overall composition of the monomers, which are fed to the polymerization reaction under polymerization conditions, remains the same or almost the same, while in a multi-phase emulsion polymerization the overall composition of the monomers, which are fed to the polymerization reaction under polymerization conditions, remains almost the same or is altered at least once, in particular such that the theoretical glass transition temperature of the resulting polymer formed in one phase differs from the theoretical glass transition temperature of the resulting polymer formed in another phase by at least 10° C., in particular by at least 20° C. or at least 40° C.

In an embodiment, the theoretical glass transition temperature of the resulting polymer formed in one phase remains almost the same of or differs from the theoretical glass transition temperature of the resulting polymer formed in another phase by at least 10° C., in particular by at least 20° C. or at least 40° C. Of course, the theoretical glass transition temperature of the resulting polymer formed in one phase can differ from the theoretical glass transition temperature of the resulting polymer formed in another phase by no more than 10° C., or no more than 5° C.

In an embodiment, the method of the invention is performed as a 2-phase emulsion polymerization, i.e., the composition of the monomers, which are fed to the polymerization reaction under polymerization conditions, is altered once, or as a 3- or 4-phase emulsion polymerization, i.e. the composition of the monomers, which are fed to the polymerization reaction under polymerization conditions, is altered twice or trice.

One aspect of the present invention relates to a method for making the polymer emulsions of the present invention, wherein the copolymer (A) is prepared by two-phase polymerization, the method comprises
Step 1: preparing the first-phase polymer by polymerizing the monomers for the first phase;
Step 2: subsequently preparing the second-phase polymer by polymerizing the monomers for the second phase;
adding emulsifier system (B) before, after or during the polymerization.

The polymerization is carried out in the presence of initiator which form radicals under the reaction conditions. The initiator may be peroxides or else azo compounds. Redox initiator systems are also contemplated, of course.

Peroxides used may in principle be inorganic peroxides and/or organic peroxides. Examples of suitable inorganic peroxides include hydrogen peroxide and also persulfates, such as the mono- or di-alkali metal or -ammonium salts of persulfuric acid, examples being its mono- and di-sodium, -potassium or -ammonium salts, such as sodium persulfate, potassium persulfate and ammonium persulfate. Examples of suitable organic peroxides are alkyl hydroperoxides such as tert-butyl hydroperoxide, aryl hydroperoxides such as p-menthyl hydroperoxide or cumene hydroperoxide, dialkyl or diaryl peroxides, such as di-(tert-butyl) peroxide, and benzoyl peroxide or di-cumene peroxide, and peroxy esters.

Azo compounds used are essentially 2,2′-azobis(isobutyronitrile), 2,2′-azobis(2-methylbutyronitrile), 2,2′-azobis(2,4-dimethylvaleronitrile), 2,2′-azobis(N,N′-dimethyleneisobutyroamidine) dihydrochloride and 2,2′-azobis(amidinopropyl) dihydrochloride.

Redox initiator systems are combined systems composed of at least one organic or inorganic reducing agent and at least one oxidizing agent. Oxidizing agents contemplated for redox initiator systems are essentially the peroxides stated above. As corresponding reducing agents it is possible to use compounds of sulfur in a low oxidation state, such as alkali metal sulfites, as for example potassium and/or sodium sulfite, alkali metal hydrogensulfites, as for example potassium and/or sodium hydrogensulfite, alkali metal metabisulfites, as for example potassium and/or sodium metabisulfite, acetone bisulfite, formaldehyde-sulfoxylates, as for example potassium and/or sodium formaldehyde-sulfoxylate, alkali metal salts, especially potassium and/or sodium salts, of aliphatic sulfinic acids, and alkali metal hydrogensulfides, such as potassium and/or sodium hydrogensulfide, for example, salts of polyvalent metals, such as iron (II) sulfate, iron (II) ammonium sulfate, iron (II) phosphate, enediols, such as dihydroxymaleic acid, benzoin and/or ascorbic acid, and also reducing saccharides, such as sorbose, glucose, fructose and/or dihydroxyacetone.

Preferred initiators are peroxy type initiators such as hydrogen peroxide, tert-butyl hydroperoxide, di-(tert-butyl) peroxide, benzoyl peroxide, peroxy esters; and persulfates such as sodium persulfate, potassium persulfate and ammonium persulfate; and azo type initiators.

The polymerization takes place in general by using 0.1 to 5% by weight of the radical initiator, preferably 0.5 to 4% by weight of the radical initiator, based in each case on the total amount of the monomers.

Initiation of the polymerization reaction refers to the start of the polymerization reaction of the monomers present in the polymerization vessel through decomposition of the radical initiator. The polymerization starts, for example, when the polymerization mixture contains monomers and inorganic peroxide and reaches a temperature in the range from 60° C. to 125° C., preferably from 70° C. to 100° C., more preferably from 80° C. to 95° C.

In addition to the above components, a molecular weight regulator may optionally be used during the emulsion polymerization to reduce/correct the molecular weight of the copolymer obtainable by the polymerization. It is possible to use predominantly aliphatic and/or aromatic halogen compounds, for example halogenated hydrocarbons, such as n-butyl chloride, n-butyl bromide, n-butyl iodide, methylene chloride, ethylene chloride, chloroform, bromoform, bromotrichloro-methane, dibromomethylene chloride, carbon tetrachloride, carbon tetrabromide, benzyl chloride, benzyl bromide, organosulfur compounds, such as aliphatic primary, secondary or tertiary mercaptans, for example ethylmercaptan, n-propylmercaptan, 2-propylmercaptan, n-butylmercaptan, 2-methyl-2-propylmercaptan, n-pentylmercaptan, 2-pentylmercaptan, 3-pentylmercaptan, 2-methyl-2-butylmercaptan, 3-methyl-2-butylmercaptan, n-hexylmercaptan, 2-hexylmercaptan, 3-hexylmercaptan, 2-methyl-2-pentylmercaptan, 3-methyl-2-pentylmercaptan, 4-methyl-2-pentylmercaptan, 2-methyl-3-pentylmercaptan, 3-methyl-3-pentylmercaptan, 2-ethylbutylmercaptan, 2-ethyl-2-butylmercaptan, n-heptylmercaptan and its isomer compounds, n-octylmercaptan and its isomer compounds, n-nonylmercaptan and its isomer compounds, n-decylmercaptan and its isomer compounds, n-undecylmercaptan and its isomer compounds, n-dodecylmercaptan and its isomer compounds, n-tridecylmercaptan and its isomer compounds, substituted mercaptans, e.g. 2-hydroxyethylmercaptan, tertiary dodecyl mercaptan, aromatic mercaptans such as benzenethiol, o-benzenethiol, m- or p-methylbenzenethiol, and all others described in Polymerhandbook, 3rd edition, 1989, J. Brandrup and E. H. Immergut, John Wiley & Sons, section II, sulfur compounds from pages 133 to 141, as well as aliphatic and/or aromatic aldehydes such as acetaldehyde, propionaldehyde and/or benzaldehyde, unsaturated fatty acids such as oleic acid, dienes with nonconjugated double bonds such as divinylmethane or vinylcyclohexane, olefins such as cyclohexene, alpha-methyl styrene and its dimer, or hydrocarbons with readily removable hydrogen atoms such as toluene.

The total amount of molecular weight regulator used during the emulsion polymerization is generally 5% by weight or less, often 3% by weight or less and often 1% by weight or less, based on the total monomers. In an embodiment, the total amount of molecular weight regulator used during the emulsion polymerization is in the range from 0.1% to 5% by weight, or 0.2 to 3% by weight, based on the total monomers.

In an embodiment, polymer seeds are used. When it is desired to set the particle size of the polymer particles obtainable by the aqueous emulsion polymerization to a specific value, polymer seeds are used in particular (see, for example, U.S. Pat. Nos. 2,520,959A and 3,397,165A). The seed may be used in an amount of from 0.01 to 5% by weight, usually from 0.05 to 3% by weight and frequently from 0.1 to 2.5% by weight of polymer seeds, based in each case on the total amount of the monomers.

One type of polymer seed used is in particular polymer seed particles which have a particle size of 60 nm or less, usually from 5 nm to 50 nm and usually from 15 nm to 35 nm, determined by light scattering.

When polymer seeds are used, it is advantageous to use exogenous polymer seeds. Unlike insitu polymer seeds, which are prepared in the reaction vessel before the actual emulsion polymerization reaction begins and which have the same monomer composition as the polymer prepared by the subsequent free-radically initiated aqueous emulsion polymerization reaction, exogenous polymer seeds are polymer seeds which are prepared in a separate reaction step and whose monomer composition differs from the polymer prepared by the aqueous emulsion polymerization reaction, although this means only different monomers, or monomer compositions having different compositions, for preparing exogenous polymer seeds and for preparing the copolymer. The preparation of exogenous polymer seeds is well known to those skilled in the art and is generally accomplished by introducing as an initial charge into a reaction vessel having a relatively small amount of monomer and a relatively large amount of surfactant, and by addition of a sufficient amount of polymerization initiator at the reaction temperature.

According to the invention, it is preferred to use exogenous polymer seeds having a glass transition temperature of more than 50° C., usually from 60 to 100° C. and often from 70° C. to 100° C. Particularly preferred are polystyrene or polymethylmethacrylate polymer seeds.

The entire amount of exogenous polymer seeds may be charged first to the polymerization reaction vessel. It is also possible to include only a portion of the exogenous polymer seeds in the initial charge being added to the polymerization vessel and to add monomers along with the remainder during the polymerization. However, if desired, the entire amount of polymer seed may also be added during the polymerization. Preferably, the entire amount of exogenous polymer seeds is first charged to the polymerization vessel prior to initiating the polymerization reaction.

The polymerization reaction may be carried out at a temperature of 60° C. to 125° C., preferably from 70° C. to 100° C., more preferably from 80° C. to 95° C. for a period of 1 to 10 hours, preferably 2 to 8 hours, more preferably 4 to 6 hours.

After the polymerization, the residue content of the monomers is generally removed in order to deodorize, such as by chemical and/or physical processes. The typical chemical and/or physical deodorization processes are known to the person skilled in the art [see, for example, EP-A771328, DE-A19624299, DE-A19621027, DE-A19741184, DE-A19741187, DE-A19805122, DE-A19828183, DE-A19839199, DE-A19840586 and 19847115]. The chemical deodorization process may be carried out by adding a further radical initiator from the group of the abovementioned initiators to the reaction mixture, or to prolong the addition thereof, and carrying out what is called an “Post-polymerization”, in other words a polymerization for achieving a conversion of 95 to 99%. It is sufficient in the majority of cases for the reaction mixture to be stirred for 0.1 to 3 hours, preferably 0.5 to 2 hours, more preferably 0.5 to 1 hour, at the polymerization temperature, after the end of the addition of monomer. The physical deodorization process may be carried out by stripping with steam or inert gas, in order to reduce the content of the monomers.

The solid content is adjusted to the desired value by dilution or concentration, or the resulted aqueous emulsion is mixed with further conventional additives, for example bactericides, foam-modifying additives or viscosity-modifying additives.

The solid content was determined by drying a defined amount of the emulsion (about 2 g) to constant weight in an aluminum crucible having an internal diameter of about 5 cm at 130° C. in a drying cabinet (2 hours). Two separate measurements were conducted. The value reported in the example is the mean of the two measurements.

The emulsion obtainable by the emulsion polymerization generally have a solid content of 10 to 70% by weight, usually 20 to 65% by weight and frequently 25 to 60% by weight, all based on the emulsion. The particle size is generally in the range of 50-300 nm, preferably in the range of 50-250 nm, and most preferably in the range of 50-200 nm. The particle size can be determined by dynamic light scattering (DLS) using a Malvern HPPS.

### Liquid Applied Sound Damping Formulation

One aspect of the present invention relates to a liquid applied sound damping formulation comprising the polymer emulsion of the present invention.

The amount of the polymer emulsion of the present invention can be in the range from 10 to 60% by weight (for example 15, 20, 25, 30, 40, 50 or 60% by weight), or from 15 to 50% by weight, or from 20 to 40% by weight, based on the total weight of liquid applied sound damping formulation.

In some embodiments, the damping formulation may include at least one of a filler, a defoaming agent, a rheological modifier, an emulsifying agent (i.e., “dispersing agent” or “dispersant”), a coalescent agent, a pigment, or a biocide.

In some embodiments, the damping formulation may include one or more fillers, which may constitute from 40% by weight to 90% by weight or from 45% by weight to 85% by weight or from 50% by weight to 80% by weight or any value or subrange within these ranges of the formulations. Examples of fillers may include, but are not limited to, calcium carbonate, barium sulfate, glass filler, magnesium carbonate, plastic microspheres, mica, powdered slate, montmorillonite flakes, glass flakes, metal flakes, graphite, graphene, talc, iron oxide, clay minerals, cellulose fibers, mineral fibers, carbon fibers, glass or polymeric fibers or beads, ferrite, calcium carbonate, calcium magnesium carbonate, calcium silicate, barytes, ground natural or synthetic rubber, silica, aluminum hydroxide, alumina and mixtures thereof. In some embodiments, the damping formulation may include a mixture of any two or more such fillers, for example calcium carbonate and mica.

In some embodiments, the damping formulation may include a defoaming agent (a defoamer). Examples of defoaming agents include Foamaster® S (produced by BASF), Rhodoline® DF 540 (produced by Solvay), Rhodoline® 635 (produced by Solvay), Foamaster® MO 2170 (produced by BASF), Foamaster® MO 2190 (produced by BASF), or Dehydran SE 2 (produced by BASF). The damping formulation may include as much of a defoaming agent as needed to provide the desired foaming characteristics. In some embodiments, the defoaming agent may constitute less than 1% by weight of the damping formulation. In some embodiments, the damping formulation can contain more than 0% by weight up to 1% by weight of the defoaming agent.

In some embodiments, the damping formulation may include a thickener or a rheological modifier. Examples of thickener and rheological modifiers include Rheovis@ HS 1152; Rheovis® HD 1152 (produced by BASF) or Rheovis® AS 1130 (produced by BASF) or Attagel 40 (produced by BASF). The damping formulation may include as much of a rheological modifier as needed to provide the desired solution characteristics. In some embodiments, the formulation may include less than 1% by weight of the rheological modifier. In other embodiments, the formulation may include more than 0% by weight up to 1% by weight (for example 0.2, 0.5, 0.8% by weight) of the thickener or rheological modifier.

In some embodiments, the damping formulation includes a dispersant. One non-limiting example of a dispersant is Dispex® CX 4320 (produced by BASF). The damping formulation may include as much dispersant as need to provide the desired characteristics for the formulation. In some embodiments, the formulation may include from 0.1 to 2.0% by weight or from 0.25 to 1.5% by weight or from 0.5 to 1.0% by weight or any value or subrange within these ranges.

A pigment or combination of pigments can also be used in the formulation of the invention. Among other properties, pigments can also be used to increase the solids content of the formulations and perform the function of a filler. Generally, any alkali stable inorganic or organic pigment can be used in the formulations of the present invention. Examples of useful pigments in the present invention include carbon black. Commercially available pigments include Aurasperse from BASF Corporation; Xfast schwarz 0066 from BASF; and Tint Ayd from Chromaflo Technologies. Preferably, it is present in an amount of from 0.2% to 5.0% by weight or 0.2% to 2.0% by weight, based on the total weight of the formulation.

In some embodiments, the damping formulation may include a biocide. Suitable non-limiting examples of a biocide include Acticide® MBS (a mixture of 1,2-benzisothiazolin-3-one (2.5%) and 2-methyl-4-isothiazolin-3-one (2.5%)), Acticide® MV-14 (a mixture of 5-chloro-2-methyl-2H-iso-thiazol-3-one and 2-methyl-2H-isothiazol-3-one in a ratio of 3:1 respectively), and Acticide® CEM 2 (a mixture of 1,2-benzisothiazol-3 (2H)-one (9.3-10.7%), 2-methylisothiazol-3 (2H)-one (4.7-5.2%), and 5-chloro-2-methyl-2H-isothiazol-3-one (0.9-1.1%).

In some embodiments, the damping formulation may be deposited on a surface of the source of mechanical vibrations in a form of a layer. Such a layer may have a thickness ranging from 0.5 mm to 12 mm or from 0.5 mm to 10 mm or from 1.0 mm to 10 mm or from 1.5 mm to 8 mm or from 2 mm to 6 mm or any value or subrange within these ranges.

The damping formulations provided herein may also be applied to a variety of materials, including, for example, metal, steel, aluminum, plastic, wood, wallboard, or gypsum board.

The damping formulation may have a viscosity at 25° C. ranging from 30,000 cPs to 120,000 cPs or from 40,000 to 100,000 cPs or any value or subrange within these ranges.

The formulation may be prepared by mixing the ingredients until a uniformly dispersed mixture is obtained. Any conventional mixing techniques can be used. The resultant formulation is storage stable. The formulation of the invention can be applied to a surface of a suitable substrate using any conventional coating technique, such as spray coating or brushing.

The present disclosure, thus generally described, will be understood more readily by reference to the following examples, which are provided by way of illustration and are not intended to be limiting of the present invention.

A further aspect of the present invention relates to use of the polymer emulsions of the present invention in liquid applied sound damping formulation.

### EXAMPLES

1. Raw Materials

| | component | from |
|---|---|---|
| BA | n-Butylacrylate (monomer a) | BASF |
| MMA | Methylmethacrylate (monomer a) | BASF |
| IA | Itaconic acid (monomer b) | Sigma-Aldrich (Shanghai) Trading Co. Ltd. |
| AA | Acrylic acid (monomer b) | BASF |
| MAA | Methacrylic acid (monomer b) | Sigma-Aldrich (Shanghai) Trading Co. Ltd. |
| beta-CEA | β-carboxyethyl acrylates (monomer b) | Sigma-Aldrich (Shanghai) Trading Co. Ltd. |
| HEMA | Hydroxyethylmethacrylate (monomer c) | BASF |
| AAEMA | 2-Acetoacetoxy-ethylmethacrylate (mono- | Sigma-Aldrich (Shanghai) Trading Co. Ltd. |
| | mer c) | |
| Gopanol VS | Sodium Vinyl Sulfonate (monomer c) | PROVIRON FUNCTIONAL CHEMICALS |
| MPEG350 | Methoxypolyethyleneglycol-500- | Evonik Resource Efficiency Gmbl |
| | methacrylate (monomer c) | |
| RS610 | RHODAFAC RS 610, aliphatic phosphate | SOLVAY (ZHENJIANG) CHEMICALS C |
| | ester emulsifier, 6 moles EO | |
| RS710 | RHODAFAC RS 710, aliphatic phosphate | SOLVAY (ZHENJIANG) CHEMICALS C |
| | ester emulsifier, 10 moles EO | |
| DB45 | Calfax DB-45, sodium dodecyl diphenyl | DOW CHEMICAL PACIFIC LTD. |
| | oxide disulfonate | |
| FES77 | Disponil FES 77, sodium salt of alkyl ether | BASF |
| | sulfate C12-14 with EO, emulsifier | |
| SUS87 | Disponil ® SUS 87 Spez., disodium | BASF |
| | ethoxylated alcohol half ester of | |
| | sulphosuccinic acid with 5EO, emulsifier | |
| tDMK | tert-Dodecylmercaptan | Sigma-Aldrich (Shanghai) Trading Co. Ltd. |
| Seed | Seed 6772, an aqueous polystyrene seed | BASF |
| | dispersion, solid content of 33 wt % | |
| sodium | | Sinopharm Group Chemical Reagent |
| persulfate | | Co., Ltd |
| ammonia | | Sinopharm Group Chemical Reagent |
| | | Co., Ltd |
| Dehydran SE 2 | Organo-modified silicone defoamer | BASF |
| Dispex CX4230 | low VOC hydrophobic dispersant | BASF |
| Xfast schwarz | carbon black | BASF |
| 0066 | | |
| 325 mesh | | OMYA MINERAL (ANHUI QINGYANG) |
| CaCO₃ | | |
| 325 mesh black | | Lingshou Li Ming Mineral Ltd. |
| mica | | |
| Attagel 40 | thickener | BASF |

### 2. Test Method

Baking property is defined as the heat resistance performance of LASD formulation. To prepare samples, LASD formulation is used to fill 2 mm and 4 mm mould on steel panel, following by removing mould and heat at 140° C. for 30 min. After cooling down to room temperature, the statues of the baked formulation are observed.

For damping performance (Composite Loss Factor (CLF), loss coefficient) test, the samples are prepared by coating formulation on a steel bar (245 mm×10 mm×1 mm). Then it is dried at 80° C. for 15 min and 140° C. for 25 min. After cooling down to room temperature, the dried formulations are cut into 180 mm in length×10 mm in width and put into Oberst tester contained in environmental chamber for Composite Loss Factor test. Testing protocol follows ASTM E 756. The loss factors are tested at 10, 20, 30, 40 and 50° C., and the peak value is considered as the highest CLF value, peak damping temperature is its corresponding temperature. The higher the loss coefficient is, the better damping performance the formulation has.

The adherence is defined as the ability of formulations to be coated on the steel bar, poor adherence means the interaction between steel and formulation is weak, thus test samples cannot survive the sample preparation or damping test.

### Example 1—Preparing Water-Borne Polymer Emulsions

### Preparation of Emulsion a1 (One-Phase Polymerization)

266.4 g deionized water, 2.4 g IA and 8.0 g Seed was added into a 2 L four-neck glass flask, and the reactor was heated to 88° C. under stirring. Then 22.8 g sodium persulfate (7% solution) was added into the reactor and hold for 5 minutes. After this, the reactor was heated to 90° C., a feeding mixture prepared with 389.6 g BA, 372.0 g MMA, 12.0 g HEMA, 8.0 g AAEMA, 32.0 g Gopanol VS (25% solution), 4.0 g AA, 4.0 g MAA, 5.6 g tDMK, 12.0 g RS610, 2.4 g FES77 and 376.0 g deionized water was fed into the reaction over 4 hours. In the meantime, 36.8 g sodium persulfate (7% solution) was fed into the reactor together with the mixture for 4 hours. After the feed, the reaction was held for 30 minutes. When the dispersion cooled down, 9.20 g 20% ammonia solution was added for neutralization. Final dispersion was filtered before further characterization and formulation. The obtained dispersion has pH of 5.3 and solid content of 50.8 wt %.

### Preparation of Emulsions a2, b1 to b6, c1 to c6, and v1 to v3 (One-Phase Polymerization)

The procedure in the preparation of emulsion a1 was repeated except that the feeding mixtures as shown in tables 1, 2 and 3 were used to prepare emulsions a2, b1 to b6, c1 to c6, and v1 to v3, respectively, wherein the feeding mixtures further comprised 5.6 g tDMK and 376.0 g deionized water, in addition to the components shown in tables 1, 2 and 3.

Emulsions v1 and v2 did not contain phosphate emulsifier and were comparative emulsions.

Emulsion v3 did not contain functional monomer (c) and was comparative emulsion.

The corresponding formulation prepared with these comparative emulsions were also comparative formulations.

### Example 2—Preparation of Liquid Applied Sound Damping Formulations

### Preparation of Formulation A1

Formulation A1 was prepared by mixing 90.0 g emulsion a1, 6.6 g water, 1.5 g Dehydran SE 2, 2.4 g Dispex CX4230, 0.9 g Xfast schwarz 0066, 150.0 g 325 mesh CaCO₃, 45.0 g 325 mesh black mica, and 3.6 g Attagel 40 in sequence with mechanical stirring. Final formulation had a viscosity of 70,000±20,000 cPs with solid content of 80±5 wt %.

### Preparation of Formulations A2, B1 to B6, C1 to C6, and V1 to V3

The procedure in the preparation of formulation A1 was repeated except that emulsion a1 was respectively replaced with emulsions a2, b1 to b6, c1 to c6, and v1 to v3 to prepare formulations A2, B1 to B6, C1 to C6, and V1 to V3, respectively.

The damping performance, baking properties and adherence properties of the liquid applied sound damping formulations were also shown in tables 1, 2 and 3.

TABLE 1

| emulsions | in weight/g | a1 | a2 | v1 | v2 |
|---|---|---|---|---|---|
| Feeding | BA | 389.6 | 389.6 | 389.6 | 389.6 |
| mixture | MMA | 372 | 372 | 372 | 372 |
| | IA | 2.4 | 2.4 | 2.4 | 2.4 |
| | AA | 4 | 4 | 4 | 4 |
| | MAA | 4 | 4 | 4 | 4 |
| | beta-CEA | | | | |
| | HEMA | 12 | 12 | 12 | 12 |
| | AAEMA | 8 | 8 | 8 | 8 |
| | Gopanol VS | 8 | 8 | 8 | 8 |
| | (solid part) | | | | |
| | MPEG350 | | | | |
| | SUM | 800 | 800 | 800 | 800 |
| | FES77 | 2.4 | 2.4 | 2.4 | 2.4 |
| | RS610 | 12 | | | |
| | RS710 | | 12 | | |
| | DB45 | | | 12 | |
| | SUS87 | | | | 12 |
| | Solid content | 50.8 | 50.5 | 49.7 | 50.4 |
| | wt % | | | | |
| | pH | 5.3 | 6.1 | 6.0 | 5.7 |
| Formulations | | A1 | A2 | V1 | V2 |
| coating weight | kg/m² | 3.4 | 3.4 | 3.4 | 3.4 |
| Loss coefficient | 10° C. | 0.105 | 0.100 | 0.094 | 0.096 |
| | 20° C. | 0.237 | 0.244 | 0.198 | 0.194 |
| | 30° C. | 0.282 | 0.271 | 0.248 | 0.233 |
| | 40° C. | 0.183 | 0.172 | 0.141 | 0.125 |
| | 50° C. | 0.091 | 0.086 | 0.074 | 0.065 |
| Total loss | | 0.898 | 0.873 | 0.755 | 0.713 |
| coefficient | | | | | |
| Damping range | ° C. | 10-49 | 10-48 | 12-46 | 11-45 |
| CLF > 0.1 | | | | | |
| Adherence | | ok | ok | ok | ok |
| Appearance after | | ok | ok | surface | surface |
| baking | | | | rough | rough |

TABLE 2

| | in | | | | | | |
|---|---|---|---|---|---|---|---|
| emulsions | weight/g | b1 | b2 | b3 | b4 | b5 | b6 |
| Feeding | BA | 389.6 | 388 | 389.6 | 389.6 | 389.6 | 389.6 |
| mixture | MMA | 372 | 372 | 372 | 372 | 372 | 372 |
| | IA | | 4 | | 2.4 | | |
| | AA | 4 | 4 | 4 | 8 | 10.4 | |
| | MAA | 4 | 4 | 6.4 | | | 10.4 |
| | beta-CEA | 2.4 | | | | | |
| | HEMA | 12 | 12 | 12 | 12 | 12 | 12 |
| | AAEMA | 8 | 8 | 8 | 8 | 8 | 8 |
| | Gopanol | 8 | 8 | 8 | 8 | 8 | 8 |
| | VS (solid | | | | | | |
| | part) | | | | | | |
| | MPEG350 | | | | | | |
| | SUM | 800 | 800 | 800 | 800 | 800 | 800 |
| | FES77 | 2.4 | 2.4 | 2.4 | 2.4 | 2.4 | 2.4 |
| | RS610 | 12 | 12 | 12 | 12 | 12 | 12 |
| | RS710 | | | | | | |
| | DB45 | | | | | | |
| | SUS87 | | | | | | |
| solid | Solid | 51.2 | 50.1 | 50.6 | 50.7 | 50.9 | 49.5 |
| content | content | | | | | | |
| | wt % | | | | | | |
| pH | pH | 5.4 | 5.4 | 6.2 | 5.6 | 5.4 | 5.8 |

| Formulations | | B1 | B2 | B3 | B4 | B5 | B6 |
|---|---|---|---|---|---|---|---|
| coating weight | kg/m2 | 3.4 | 3.4 | 3.4 | 3.5 | 3.4 | 3.3 |
| Loss | 10° C. | 0.093 | 0.085 | 0.073 | 0.085 | 0.097 | 0.080 |
| coefficient | 20° C. | 0.217 | 0.223 | 0.183 | 0.195 | 0.183 | 0.172 |
| | 30° C. | 0.278 | 0.314 | 0.278 | 0.276 | 0.233 | 0.237 |
| | 40° C. | 0.195 | 0.209 | 0.179 | 0.157 | 0.148 | 0.163 |
| | 50° C. | 0.105 | 0.113 | 0.090 | 0.078 | 0.077 | 0.093 |
| Total loss | | 0.888 | 0.944 | 0.803 | 0.791 | 0.738 | 0.745 |
| coefficient | | | | | | | |
| Damping range | ° C. | 11-50 | 12-51 | 13-49 | 12-47 | 11-47 | 14-46 |
| CLF > 0.1 | | | | | | | |
| Adherence | | ok | ok | ok | ok | ok | ok |
| Appearance | | ok | ok | ok | ok | ok | ok |
| after baking | | | | | | | |

TABLE 3

| | in | | | | | | | |
|---|---|---|---|---|---|---|---|---|
| emulsions | weight/g | c1 | c2 | c3 | c4 | c5 | c6 | v3 |
| Feeding | BA | 389.6 | 389.6 | 393.6 | 393.6 | 389.6 | 389.6 | 404.8 |
| mixture | MMA | 368 | 372 | 376 | 376 | 372 | 372 | 384.8 |
| | IA | 2.4 | 2.4 | 2.4 | 2.4 | 2.4 | 2.4 | 2.4 |
| | AA | 4 | 4 | 4 | 4 | 4 | 4 | 4 |
| | MAA | 4 | 4 | 4 | 4 | 4 | 4 | 4 |
| | beta-CEA | | | | | | | |
| | HEMA | 12 | 12 | 12 | 12 | 20 | | |
| | AAEMA | 12 | | 8 | | | | |
| | Gopanol | 8 | 8 | | 8 | 8 | 28 | |
| | VS (solid | | | | | | | |
| | part) | | | | | | | |
| | MPEG350 | | 8 | | | | | |
| | SUM | 800 | 800 | 800 | 800 | 800 | 800 | 800 |
| | FES77 | 2.4 | 2.4 | 2.4 | 2.4 | 2.4 | 2.4 | 2.4 |
| | RS610 | 12 | 12 | 12 | 12 | 12 | 12 | 12 |
| | RS710 | | | | | | | |
| | DB45 | | | | | | | |
| | SUS87 | | | | | | | |
| solid | Solid | 50.4 | 51.0 | 51.5 | 50.7 | 51.4 | 51.1 | 50.9 |
| content | content | | | | | | | |
| | wt % | | | | | | | |
| pH | pH | 5.6 | 5.5 | 5.6 | 5.5 | 5.8 | 5.6 | 5.7 |

| Formulations | | C1 | C2 | C3 | C4 | C5 | C6 | V3 |
|---|---|---|---|---|---|---|---|---|
| coating | kg/m² | 3.3 | 3.4 | 3.3 | 3.5 | 3.3 | 3.3 | / |
| weight | | | | | | | | |
| Loss | 10° C. | 0.099 | 0.091 | 0.077 | 0.072 | 0.093 | 0.096 | / |
| coefficient | 20° C. | 0.221 | 0.183 | 0.191 | 0.170 | 0.183 | 0.202 | / |
| | 30° C. | 0.278 | 0.266 | 0.287 | 0.268 | 0.264 | 0.217 | / |
| | 40° C. | 0.179 | 0.168 | 0.193 | 0.178 | 0.180 | 0.133 | / |
| | 50° C. | 0.097 | 0.081 | 0.096 | 0.086 | 0.089 | 0.068 | / |
| Total loss | | 0.874 | 0.789 | 0.844 | 0.774 | 0.774 | 0.716 | / |
| coefficient | | | | | | | | |
| Damping | ° C. | 10-50 | 11-47 | 13-48 | 13-48 | 11-48 | 10-45 | / |
| range | | | | | | | | |
| CLF > 0.1 | | | | | | | | |
| Adherence | | ok | ok | ok | ok | ok | ok | poor |
| Appearance | | ok | ok | ok | ok | ok | ok | / |
| after baking | | | | | | | | |

Results in tables 1, 2 and 3 showed that the liquid applied sound damping (LASD) formulation prepared from the emulsions according to the present invention had improved adherence, appearance and damping performance, for example high loss coefficient, high damping peak and broad damping curve (damping range CLF>0.1). Comparative LASD formulations prepared from the emulsions without using phosphate emulsifier showed poor appearance (V1 and V2). Comparative LASD formulation (V3) prepared from the emulsion without using functional monomer failed in the test as slurry detached easily from substrate.

It will be apparent to those skilled in the art that various modifications and variations can be made in the present invention without departing from the scope or spirit of the invention. Thus, it is intended that the present invention cover such modifications and variations as come within the scope of the appended claims and their equivalents.

1.-14. (canceled)

15. A water-borne polymer emulsion comprises:
(A) a copolymer prepared by polymerization of at least one hydrophobic monoethylenically unsaturated monomer (a), hydrophilic monoethylenically unsaturated monomer (b), and at least one functional monomer (c);
wherein the functional monomer (c) is selected from the group consisting of an ethylenically unsaturated monomer having an acid group and/or the corresponding anion thereof, an ethylenically unsaturated monomer having an amino, amido, ureido, 1,3-diketo group, hydroxyl, polyether chain, or N-heterocyclic group and/or protonated on the nitrogen, or alkylated ammonium derivatives thereof;
wherein the functional monomer (c) is different from monomer (a) and monomer (b); and
(B) an emulsifier system, wherein the emulsifier system comprises at least one phosphate emulsifier.

16. The water-borne polymer emulsion according to claim 15, wherein the total amount of hydrophobic monoethylenically unsaturated monomers (a) may be in an amount of at least 80% by weight or from 80 to 99% by weight, based on the total amount of all monomers.

17. The water-borne polymer emulsion according to claim 15 wherein the total amount of hydrophilic monoethylenically unsaturated monomers (b) may be in an amount of at least 0.1% by weight and no more than 20% by weight, based on the total amount of all monomers.

18. The water-borne polymer emulsion according to claim 15, wherein the hydrophobic monoethylenically unsaturated monomer (a) is selected from the group consisting of (meth)acrylate monomers, (meth)acrylonitrile monomers, styrene monomers, vinyl alkanoate monomers and monoethylenically unsaturated di- and tricarboxylic ester monomers.

19. The water-borne polymer emulsion according to claim 15, wherein the hydrophilic monoethylenically unsaturated monomer (b) is selected from the group consisting of monoethylenically unsaturated dicarboxylic acid, acrylic acid, methacrylic acid, and β-carboxyethyl acrylate.

20. The water-borne polymer emulsion according to claim 15, wherein the hydrophilic monoethylenically unsaturated monomer (b) comprises at least two monomers selected from itaconic acid, acrylic acid, methacrylic acid and β-carboxyethyl acrylate.

21. The water-borne polymer emulsion according to claim 15, wherein the functional monomer (c) comprises at least two monomers selected from the group consisting of an ethylenically unsaturated monomer having an acid group and/or the corresponding anion thereof, an ethylenically unsaturated monomer having an amino, amido, ureido, 1,3-diketo group, hydroxyl, polyether chain, or N-heterocyclic group and/or protonated on the nitrogen, or alkylated ammonium derivatives thereof.

22. The water-borne polymer emulsion according to claim 15, wherein the copolymer (A) is prepared by one-phase polymerization.

23. The water-borne polymer emulsion according to claim 15, wherein the copolymer (A) is prepared by two-phase polymerization, wherein the monomers for the first-phase comprise monomer (a), and (b) and/or (c), the monomers for the second-phase comprise monomer (a), and optionally (b) and/or (c), wherein the weight ratio of the first-phase polymer:second-phase polymer is in the range of 95:5 to 40:60.

24. The water-borne polymer emulsion according to claim 15, wherein the emulsion has a particle size in the range of 50-300 nm.

25. A method for making the polymer emulsions according to claim 22, comprising: preparing copolymer (A) by polymerization of monomer (a), monomer (b), and monomer (c) and adding the emulsifier system (B) before, after or during the polymerization.

26. A method for making the polymer emulsions according to claim 23, comprising:
Step 1: preparing the first-phase polymer by polymerizing the monomers for the first phase;
Step 2: subsequently preparing the second-phase polymer by polymerizing the monomers for the second phase;
adding emulsifier system (B) before, after or during the polymerization.

27. A liquid applied sound damping formulation comprising the polymer emulsion according to claim 15.

28. Use of the polymer emulsions according to claim 15 in liquid applied sound damping formulation.
